(19) United States
(12) Patent Application Publication
(10) Pub. No.: US 2016/0063766 A1
(43) Pub. Date: Mar. 3, 2016

(54) METHOD AND APPARATUS FOR CONTROLLING THE NOTIFICATION INFORMATION BASED ON MOTION

(71) Applicant: Samsung Electronics Co., Ltd., Gyeonggi-do (KR)

(72) Inventors: Woojung HAN, Seoul (KR); Seunghwan HONG, Gyeonggi-do (KR); Sora KIM, Seoul (KR); Seoyoung YOON, Seoul (KR)

(21) Appl. No.: 14/838,664

(22) Filed: Aug. 28, 2015

(30) Foreign Application Priority Data
Aug. 29, 2014 (KR) 10-2014-0114575

(51) Int. Cl. G06T 19/00; G06F 3/0481; G06F 3/01; G02B 27/01

(52) U.S. Cl. CPC G06T 19/006; G02B 27/017; G06F 3/04817; G06F 3/017; G02B 2027/0178

(57) ABSTRACT

Various embodiments of the present disclosure relates to a method of controlling notification information based on a user's movement in a virtual reality environment. The method comprises displaying a virtual reality (VR) content execution screen; displaying a notification icon on at least a portion of the VR content execution screen when a notification is received; determining that a position of a user's sight line reaches a position at which the notification icon is displayed; and displaying notification information corresponding to the notification icon on the VR content execution screen.

### CLAIM OF PRIORITY

This application claims priority from and the benefit under 35 U.S.C. §119(a) of Korean Patent Application No. 10-2014-0114575, filed on Aug. 29, 2014, which is hereby incorporated by reference for all purposes as if fully set forth herein.

### BACKGROUND

Various embodiments of the presented herein relate to method(s) and apparatus of controlling notification information based on user motion in a virtual reality environment.

A display unit of an electronic device may be enlarged and a user's need for a screen fully filling the visual field has increased. An electronic device wearable like eyeglasses, and a frame device which can be combined with a user device such as a smart phone may exist. Using the glasses type of wearable electronic device, a screen can be displayed on the entire range in which user's sight line is affected. Therefore, it is possible to utilize a virtual reality content such as a Virtual Reality (VR) environment based game and movie.

### SUMMARY

An electronic device that is wearable like eyeglasses on the head may be referred to as a head mount device. The head mount device may include a display unit and may be combined with an electronic device including the display unit. When the head mount device is used by being combined with the electronic device including the display unit, various notification situations such as a message reception, a call reception, or a push notification of an application may be generated. In the foregoing event, user would have to separate the electronic device from the head mount device in order to response to the corresponding notification or have to take off the worn head mount device. The foregoing would be an inconvenience for a user.

Certain embodiment(s) are presented herein to avoid the foregoing inconvenience and enable an electronic device to, when a notification is generated while the electronic device is connected to a head mount device and is providing a VR environment, control a corresponding notification screen according to user motion without separating the electronic device from the head mount device.

In some embodiments, there may be provided a method of controlling notification information, the method comprising: displaying a virtual reality (VR) content execution screen; displaying a notification icon on at least a portion of the VR content execution screen when a notification is received; determining that a position of a user's sight line reaches a position at which the notification icon is displayed; and displaying notification information corresponding to the notification icon on the VR content execution screen.

In accordance with other embodiments, there is provided an electronic device for controlling notification information. The electronic device may include: a display unit for displaying a virtual reality (VR) content execution screen and displaying a notification icon on at least a portion of the virtual reality (VR) content execution screen; a sensor unit for detecting a motion of the electronic device; and a controller for a position of a user's sight line according to the detected motion and controlling notification information correspoding to the notification icon on the VR content execution screen when the position of a user's sight line reaches a notification display window.

Other embodiments enable an electronic device to, in various notification situations generated while the electronic device is connected to a head mount device and is providing a VR environment, identify the notification or perform a function corresponding to the notification even without separating the electronic device from the head mount device.

### BRIEF DESCRIPTION OF THE DRAWINGS

The above features and advantages of the various embodiments presented herein will be more apparent from the following detailed description in conjunction with the accompanying drawings, in which:

FIG. 1 illustrates a connection of an electronic device and a head mount device according to various embodiments presented herein;

FIG. 2 is a block diagram illustrating a configuration of an electronic device according to various embodiments presented herein;

FIG. 3 is a flow chart illustrating a flow of an operation according to various embodiments presented herein;

FIGS. 4A and 4B illustrate a notification information display according to a user's sight line movement in a Virtual Reality (VR) environment according to various embodiments presented herein;

FIG. 5 illustrates a notification information minimization operation according to various embodiments presented herein;

FIG. 6 illustrates a method of identifying a message during a VR content execution according to various embodiments presented herein;

FIG. 7 illustrates a message notification display operation according to various embodiments presented herein;

FIG. 8 is a flow chart illustrating a flow of a notification information display operation during a VR content execution according to various embodiments presented herein; and

FIGS. 9A to 9C illustrate an operation of displaying a call reception window according to various embodiments presented herein.

### DETAILED DESCRIPTION

Hereinafter, the present disclosure will be described with reference to the accompanying drawings. The present disclosure may have various modifications and embodiments and thus will be described in detail with reference to specific embodiments illustrated in the drawings. However, it should be understood that the present disclosure is not limited to the particular embodiments, but includes all modifications, equivalents, and/or alternatives within the spirit and scope of the present disclosure. In the description of the drawings, identical or similar reference numerals are used to designate identical or similar elements.

In the present disclosure, the expression “include” or “may include” refers to existence of a corresponding function, operation, or element, and does not limit one or more additional functions, operations, or elements. In the present disclosure, the terms such as “include” and/or “have” may be construed to denote a certain characteristic, number, step, operation, constituent element, element or a combination thereof, but may not be construed to exclude the existence of or a possibility of addition of one or more other characteristics, numbers, steps, operations, constituent elements, elements or combinations thereof.

In the present disclosure, the expression “or” includes any or all combinations of words enumerated together. For example, the expression “A or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices.

For example, a first element could be termed a second element, and similarly, a second element could be also termed a first element without departing from the scope of the present disclosure.

In the case where an element is referred to as being “connected” or “accessed” to other elements, it should be understood that not only the element is directly connected or accessed to the other elements, but also another element may exist between them. Contrarily, when an element is referred to as being “directly coupled” or “directly connected” to any other element, it should be understood that no element is interposed therebetween.

In the present disclosure, the terms are used to describe a specific embodiment, and are not intended to limit the present invention. As used herein, the singular forms are intended to include the plural forms as well, unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present specification.

An electronic device according to embodiments of the present disclosure may be a device including a communication function. For example, the electronic device includes at least one of a smart phone or a tablet Personal Computer.

Hereinafter, an electronic device according to various embodiments will be described with reference to the accompanying drawings. The term “user” used in various embodiments may refer to a person who uses an electronic device or a device (for example, an artificial intelligence electronic device) that uses an electronic device.

An electronic device may support a Virtual Reality (VR) environment to a user by being docked with a head mount device.

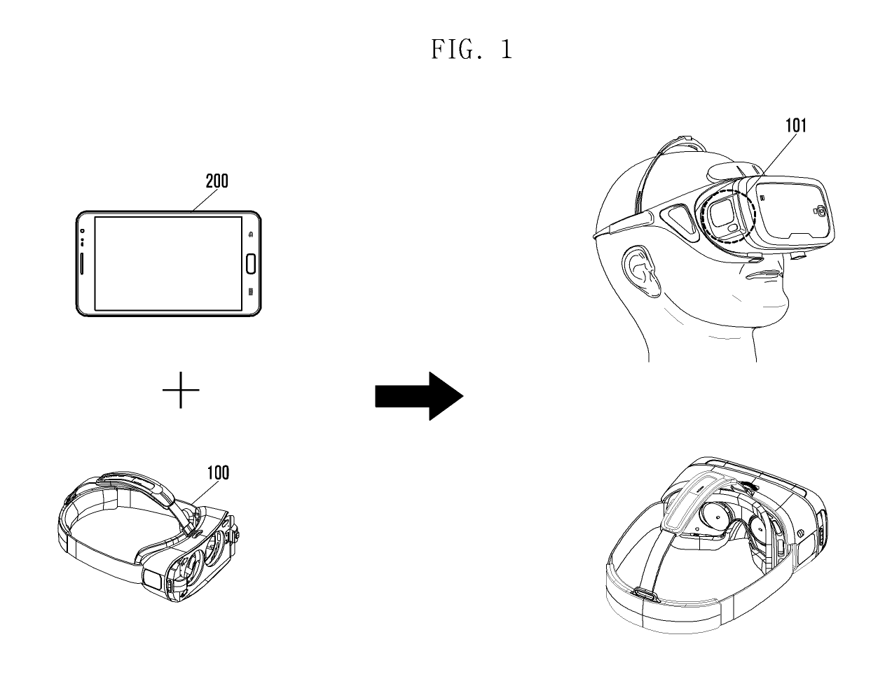

FIG. 1 illustrates an electronic device and a peripheral device which interworks with the electronic device to provide the VR environment.

Referring to FIG. 1, an electronic device 200 may be combined with a head mount device 100 which provides the VR environment and is wearable. The head mount device 100 may include a touch pad 101 or a function key (not shown) on the one side. The head mount device 100 may transfer a user input received from the touch pad 101 or the function key to the electronic device 200. In this event, the head mount device 100 and the electronic device 200 can be wirelessly connected using wired or short-range wireless communication.

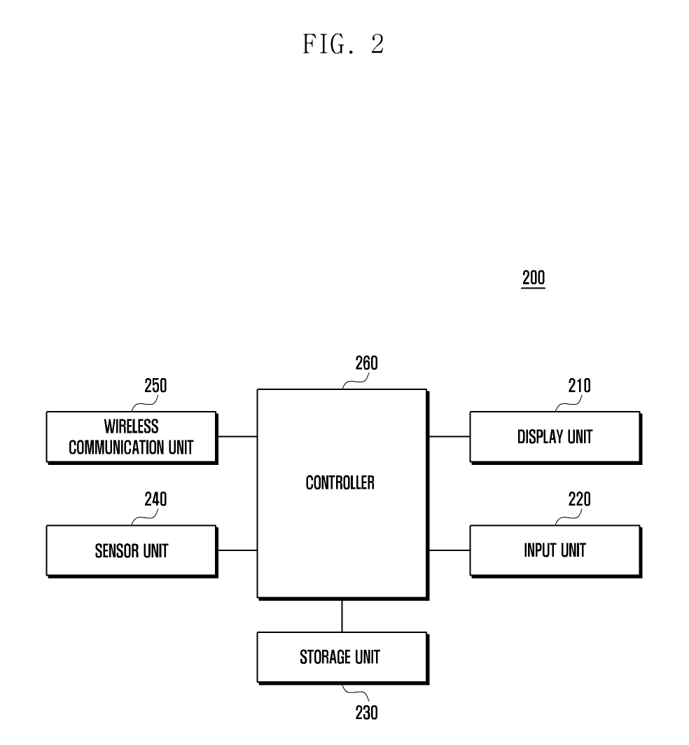

First, a configuration of an electronic device according to various embodiments will be described with reference to FIG. 2.

FIG. 2 is a block diagram illustrating a configuration of an electronic device.

Referring to FIG. 2, an electronic device 200 may include a display unit 210, an input unit 220, a storage unit 230, a sensor unit 240, a communication unit 250, and a controller 260.

The display unit 210 may be formed by a Liquid Crystal Display (LCD), Organic Light Emitting Diodes (OLED), and Active Matrix Light Emitting Diodes (AMOLED), and visually provides various information such as a menu of the electronic device, input data, and function configuration information to the user.

The display unit 210 according to the embodiment of the present invention may display a left image and a right image in a first display area and a second display area, respectively, in a Virtual Reality (VR) environment. The VR environment may be created when the electronic device 200 is stably placed on the head mount device 100 (e.g., a Head Mounted Theater (HMT) frame) which can interworks with the electronic device 200. Specifically, when the electronic device 200 is docked with the head mount device, the electronic device 200 may configure the first display area and the second display area in the display unit 210. Further, the first display area and the second display area may display images to be viewed by a user's left eye and right eye, respectively. When the head mount device 100, with which the electronic device 200 is docked, is worn on the user's head, the user views two kinds of images displayed in the display unit 210 of the electronic device 200 through both eyes and may recognize one image by autonomously synthesizing the two kinds of images.

The input unit 220 corresponds to a device for detecting a user input. The input unit 220 may detect a touch input through a key input and a touch panel. The input unit 220 may detect a user touch or a key input to transmit them to the controller 260. The input unit 220 according to the embodiment of the present invention may receive a user input requesting an execution of a content (e.g., a VR game) which can supports the VR environment. In addition, the input unit 220 may receive a user input required to adjust details related to a display and a sound configuration during the VR content execution. The storage unit 230 may store commands or data that are received from the controller 260 or other elements or generated by the controller 260 or other elements. The storage unit 230 according to may store a program for implementing the VR environment. For example, when the electronic device 200 detects that the electronic device 200 has been docked with the head mount device 100, the storage unit 230 may store a program to implement the VR environment in which a screen is divided and content is displayed in each of two display areas. In addition, the storage unit 230 may store content which can support the VR environment (e.g., the VR game).

The sensor unit 240 may detect an operation of movement and motion of the electronic device 200. The sensor unit 240 may include, for example, an acceleration sensor and a gyro-sensor. The sensor unit 240 according to the embodiment of the present invention may detect a user motion for identifying information on a notification generated during the VR content display. For example, the sensor unit 240 may detect a user's head motion for selecting a notification displayed on one side of the screen. The detected motion may be used as a basis on which a point considered as the position of the user's sight line moves.

The communication unit 250 may support wired/wireless communication between the electronic device 200 and another device. The communication unit 250 according to the embodiment of the present invention may support wired/wireless communication between the electronic device 200 and the head mount device 100. For example, the electronic device 200 may perform wired communication by being attached to a connection device existing on one point of the head mount device 100. Also, the electronic device 200 may wirelessly communicate with the head mount device 100 using Bluetooth a short-range communication scheme such as Near Field Communication (NFC). When being connected to the head mount device 100 through the wired or wireless communication, the communication unit 250 may transmit a signal indicating whether the communication unit 250 is connected to the head mount device 100 to the controller 260. When identifying that communication unit 250 has been connected to the head mount device 100, the controller 260 may cause the screen to display content based on the VR environment, now referred to as a “VR content execution screen.”

The controller 260 may control general operations of the electronic device.

When the electronic device 200 is connected to a peripheral device (such as the head mount device 100) through a communication channel by the communication unit 250 and is thus in a state in which communication is possible, the controller 260 according to the embodiment of the present invention may support the VR environment which displays the screen through two display areas. Further, the controller 260 may cause the display unit 210 to display specific content according to the VR environment. In this event, content displayed through two display areas in the VR environment may be referred to as a VR content. In addition, when a user performs a motion such as lifting the user's head or bowing the user's head, or turning the user's head to the left or right, the motion may be detected through the sensor unit 240, and the controller 260 may receive information on a degree and a direction for the motion from the sensor unit 240. Further, the controller 260 may determine coordinates of a place (hereinafter, referred to as a “position of sight line” or “position of the user's sight line”) for the convenience of the description) which is considered as a point where the user views on the screen of the VR content on the basis of information, received from the sensor unit 240, on a motion degree and direction of the user. When the sensor unit 240 has detected the motion of the electronic device 200, the controller 260 may move coordinates of a position of the user's sight line in response to the detected motion. The controller 260 may display the position of the user's sight line using a specific mark such that the position can be recognized by the user. When a mark which representing the position of the user's sight line reaches a point where a notification icon is displayed, the controller 260 may display corresponding notification information on the screen. The corresponding notification information may be displayed on the pop-up window such as a message display window and a call reception window. The controller 260 may continuously display the notification information while the position of the user's sight line stays in an area (e.g., the message display window) where the notification information is displayed. Meanwhile, when the position of the user's sight line moves outside of the area where the notification information is displayed, the controller 260 may terminate display of the notification information. Further, the controller 260 may perform a menu selection operation in response to a touch operation (e.g., a tap and a swipe) detected by the touch pad 101 of the head mount device 100. For example, in a case in which the notification information (e.g., a call reception window) is displayed, when a touch is input through the touch pad 101 in a state in which the position of the user's sight line stays at a selection menu (e.g., an “acceptance” button) existing in the notification information, the controller 260 may execute a function (e.g., a call connection) corresponding to the selection menu.

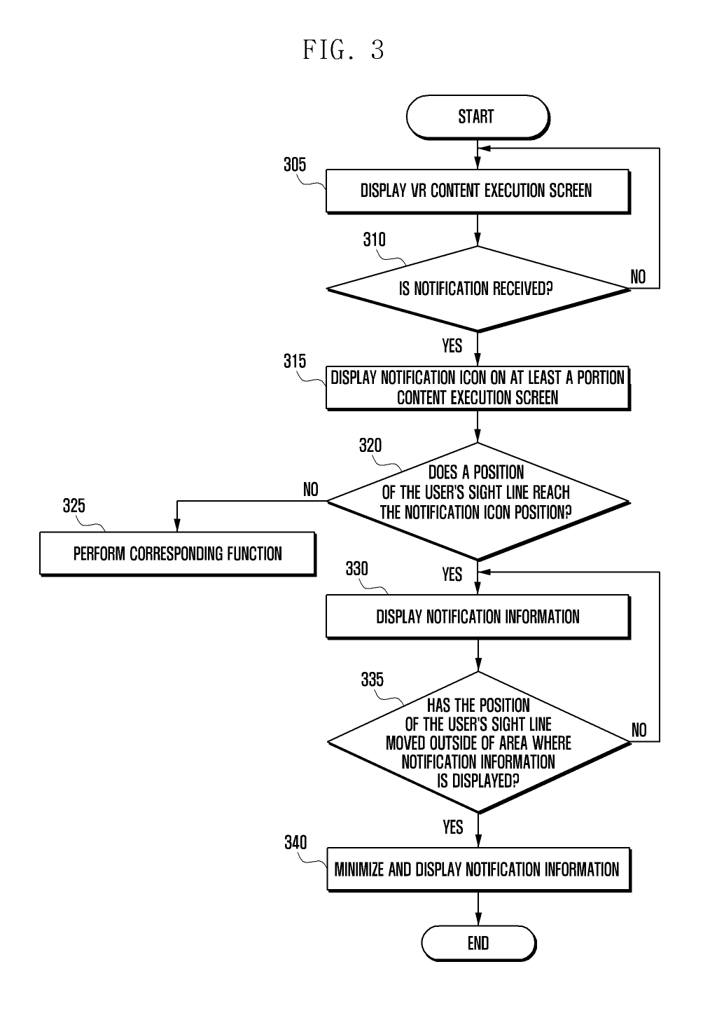

Hereinafter, an operation according to the embodiment of the present invention will be described with reference to FIGS. 3 to 7.

FIG. 3 is a flow chart illustrating a flow of operations according to an embodiment of the present invention.

Referring to FIG. 3, the controller 260 may display a VR content execution screen in operation 305. The VR content may include, for example, a 3D game. VR content execution screen refers to the result of the graphical rendering of VR content that is displayed on the screen. The VR content may separately generate a left image which is an image to be viewed by a left side eye of a user and a right image to be viewed by at a right eye of the user and then may display the left image and the right image in two display areas, respectively. Further, an identical image may be displayed in the two display areas. Therefore, the user views an image displayed in each of the two display areas through the left eye and the right eye, thereby viewing one overlapping image which is displayed in an entire visual field.

During display of the VR content execution screen in operation 305, the controller 260 may detect that a notification is received in operation 310. The notification may include a notification for a message reception or a call reception. Further, the notification may include, for example, a push notification related to an application, a message arrival notification, or the like.

When the notification reception is not generated, the controller 260 may continuously display the VR content execution screen in operation 305. However, when identifying that the notification has been received, the controller 260 may display a notification icon on at least a portion, such as a side, of the VR content execution screen in operation 315. In addition, when the notification is received, a display method including a graphic object such as an icon, a color change, and animation may be used. For example, the controller 260 may display a telephone shape of notification icon on a side of the content execution screen during the call reception. The notification icon may be displayed differently according to the type of notification or the content of the notification. For example, when a text message has been received, the controller 260 may display a text box icon on a side which does not completely cover the VR content execution screen. If an email is received, the controller 260 may display an envelope icon on a side which does not cover the VR content execution screen. If a voicemail is received, the controller 260 may display an icon that appears like an audio cassette tape. In certain cases event, a notification icon displayed on at least one portion of the VR content execution screen may perform an effect such as flickering in order to effectively notify a user who is watching the VR content on the VR content execution screen.

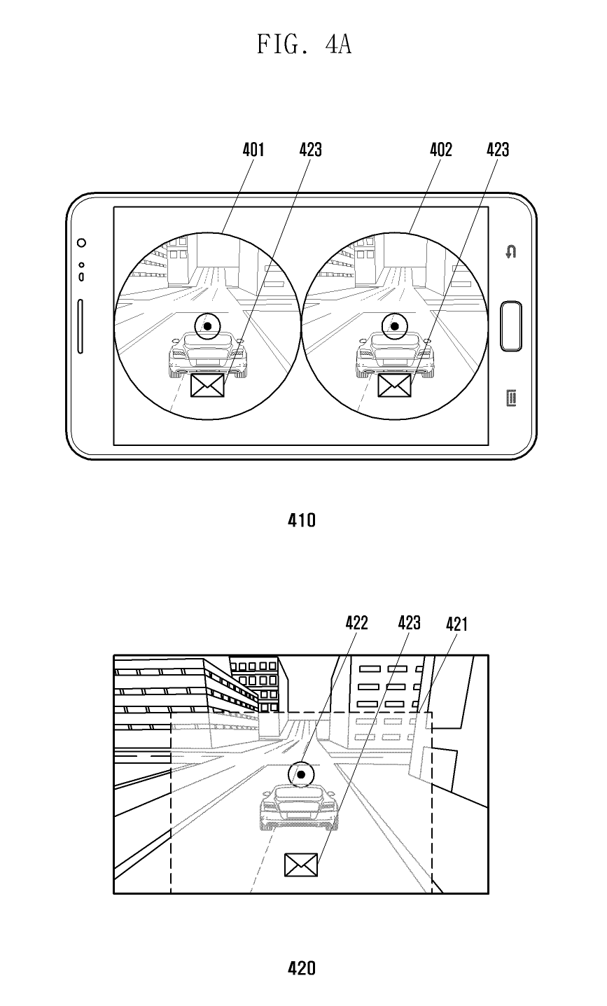

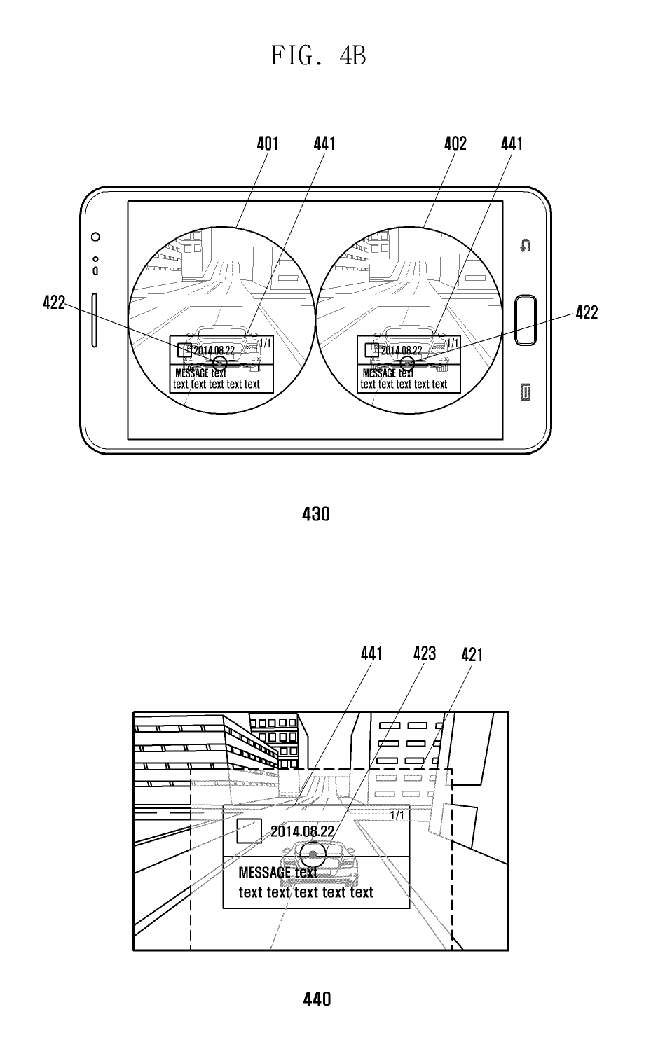

Then, the controller 260 may determine whether a position of a user's sight line reaches a position where the notification icon is displayed in operation 320. In this event, the controller 260 can utilize data related to a user's head motion detected from the sensor unit 240 in order to understand a motion of a position of a user's sight line. The controller 260 can search for an area to come into a user's visual field in an overall content area and a position corresponding to a position of the user's sight line, according to the user's head motion. When the user's sight line reaches a position where a specific notification icon is displayed, the controller 260 may display notification information corresponding to the notification icon on the VR content execution screen in operation 330. A detailed description for operations 320 to 330 in which the notification information is displayed on the screen as the position of the user's sight line reaches the notification icon will be described with reference to FIGS. 4A and 4B below.

Meanwhile, when the position of the user's sight line does not reach the area where the notification icon is displayed, the controller 260 may perform a corresponding function in operation 325. The operation 325 may correspond to an operation of selectively terminating a notification according to a kind of notification when a predetermined period of time elapses. For example, although a notification icon which indicates an incoming call is displayed on the screen according to the incoming call, when the position of the user's sight line does not reach a position of the notification icon during the predetermined period of time, the display of the notification icon may be terminated.

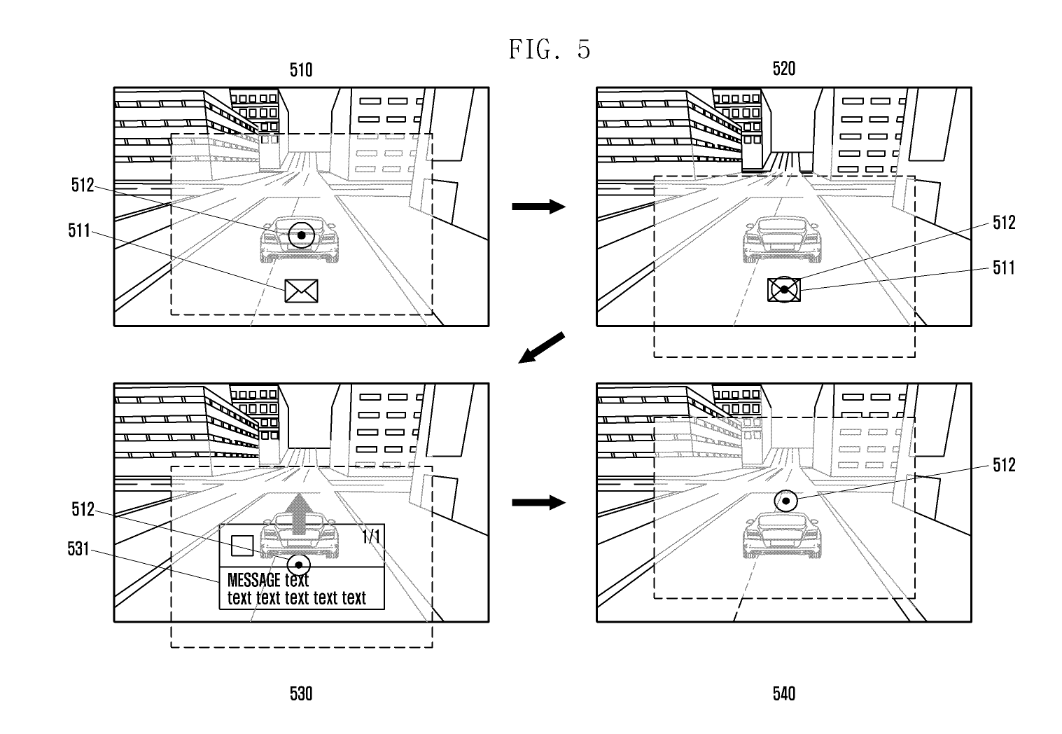

When the position of the user's sight line is in an area where the notification icon is displayed, the controller 260 displays notification information corresponding to the notification icon on the screen in operation 330. When it is determined that the position of the user's sight line stays in the notification information display area, that is, when the user's head motion is not detected after the notification information is displayed, the controller 260 may continuously perform operation 330. Meanwhile, when the controller 260 determines that the user's sight line moves out of the area where the notification information is displayed in operation 335, operation 340 may be performed. The controller 260 may minimize notification information and then display the notification information in operation 340. However, it is not limited thereto, and when the user's sight line moves out of the area where the notification information is displayed, the controller 260 may terminate the display of the notification information. Operations 335 to 340 of minimizing notification information according to the sight line move will be described with reference to FIG. 5.

FIGS. 4A and FIG. 4B illustrate notification information display according to a position of a user's sight line movement in a Virtual Reality (VR) environment.

FIG. 4A is a diagram of a VR content execution screen 410 that is displayed in each of two display areas 401 and 402 in a VR environment in an electronic device 200. For example, when being mounted to a head mount device 100, the electronic device 200 may perform an operation of displaying the screen in two display areas 401 and 402. In addition, the VR content execution screen displayed in each of the two display areas 401 and 402 may be viewed by each of a left eye and a right eye of a user. When the user views the screen displayed in the two display areas 401 and 402 through the left eye and the right eye, one image may be recognized as indicated by reference numeral 420. A VR content execution screen displayed through each of the two display areas 401 and 402 reaches the user's eyes through a left lens and a right lens of the head mount device 100. Therefore, the two display areas 401 and 402 are not only divided, but may be configured as a circle depending on a shape of the lens of the head mount device 100 and nothing may be displayed on the outside of the display areas 401 and 402. Further, sizes of the display areas 401 and 402 may be configured according to a size of a lens aperture of the head mount device 100.

In this event, the controller 260 may distinguish and display a corresponding point on the screen 422 so as to make a position of the user's sight line easily recognized by the user. The position of the user's sight line may be determined as a center position of a user's visual field 421. The user's visual field 421 may also move according to a user motion detected from the electronic device 200 and may be allocated to a portion of an area in a full screen displayed in the electronic device 200. When, for example, notification for a message reception is generated in the electronic device 200 during the display of the VR content, the notification 423 notifying the message reception may be displayed on a side of the screen.

Referring to FIG. 4B, it may be identified that a mark 422 notifying the position of the user's sight line is at the center of a VR content execution screen above the notification icon 421 and a display window 441 displaying a message content may be displayed on the screen. The electronic device 200 detects a user's head motion and determines that the position of a user's sight line has moved according to the detected motion. When the position of the user's sight line, reaches a position of the notification icon 423, the controller 260 may cause the display window 441 to display message content as shown in screen shots 430 and 440. In addition, when the user views the VR content execution screen displayed in the two display areas 401 and 402 through each of the left eye and the right eye, an screenshot 440 is displayed. A dotted line area 421 as shown in screenshots 420 and 440 represents a user's visual field. A position of the user's sight line 422 may be considered to be in a center point of the user's visual field 421. That is, it may be considered that the position of the user's sight line is in the center point of the visual field 421 and the position of the user's sight line has moved to the left and right or up and down as a head moves left and right or up and down.

FIG. 5 illustrates screenshots 510, 520, 530, and 540 demonstrating a notification information minimization operation.

Screenshot 510 shows a notification icon 511 that is displayed on a side of the VR content execution screen according to a message reception while the VR content execution screen is displayed. In this event, the position of the user's sight line 512 is positioned above a message notification icon 511. When the notification icon 511 is displayed on at least a portion of the VR content execution screen, a user may cause the position of the user's sight line 512 to reach to the position of the notification icon 511. The electronic device 200 may detect a user's head motion through the sensor unit 240 in order to determine that the position of the user's sight line moves. When the user lowers the user's head, the electronic device 200 may detect the user's motion and the position of the sight line moves to a lower end of the screen. When the user's sight line moves and then reaches the notification icon 511, information on a corresponding notification in a display window 531 may be displayed on the VR content execution screen. The controller 260 of the electronic device 200 may continuously display a display window 531 while a point considered as the position of the user's sight line 512 stays in the display window 531 (e.g., a message window) in which information on the notification is displayed. When the position user's sight line 512 moves outside of the display window 531 by moving in a direction of the arrow in screenshot 530, the display window 531 may be minimized or be displayed at a side of the screen in an initial notification state (e.g., a notification icon). In addition, according to certain embodiments, when it is determined that the position of the user's sight line moves outside the display window 531, the controller 260 may terminate an operation of displaying the display window 531 depending on the kind of the notification information displayed on the screen. For example, if the display window 531 is a message display window displaying a content of the message and it is determined that there is no more unidentified message among the received messages, the controller 260 may terminate the display window when the position of the user's sight line moves outside of the display window, as indicated by screenshot 540.

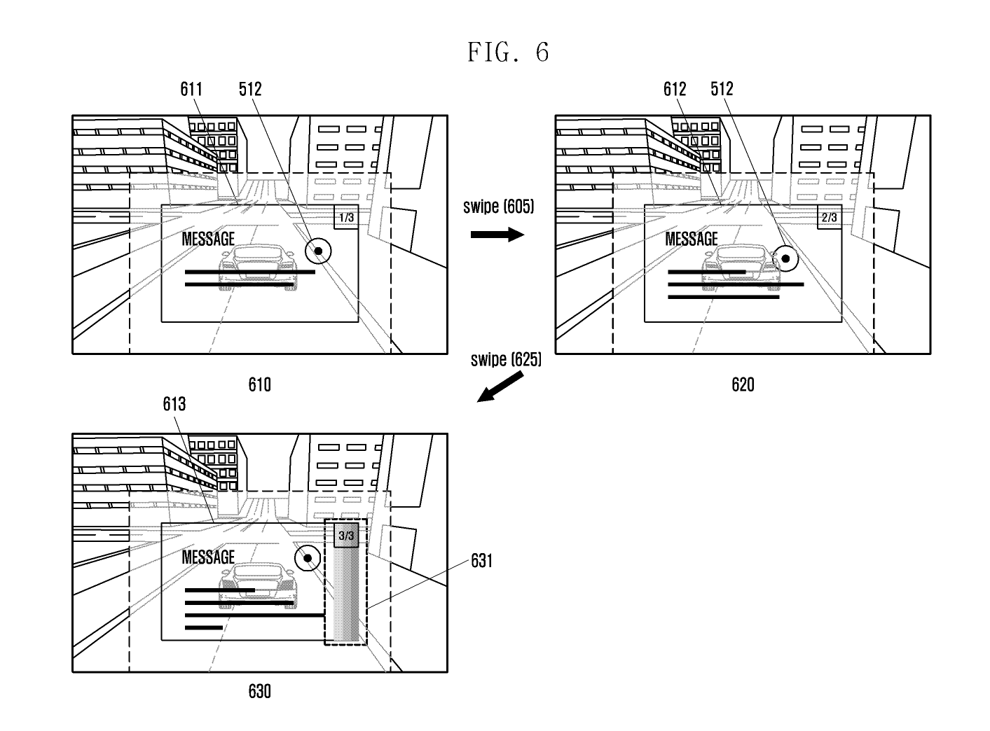

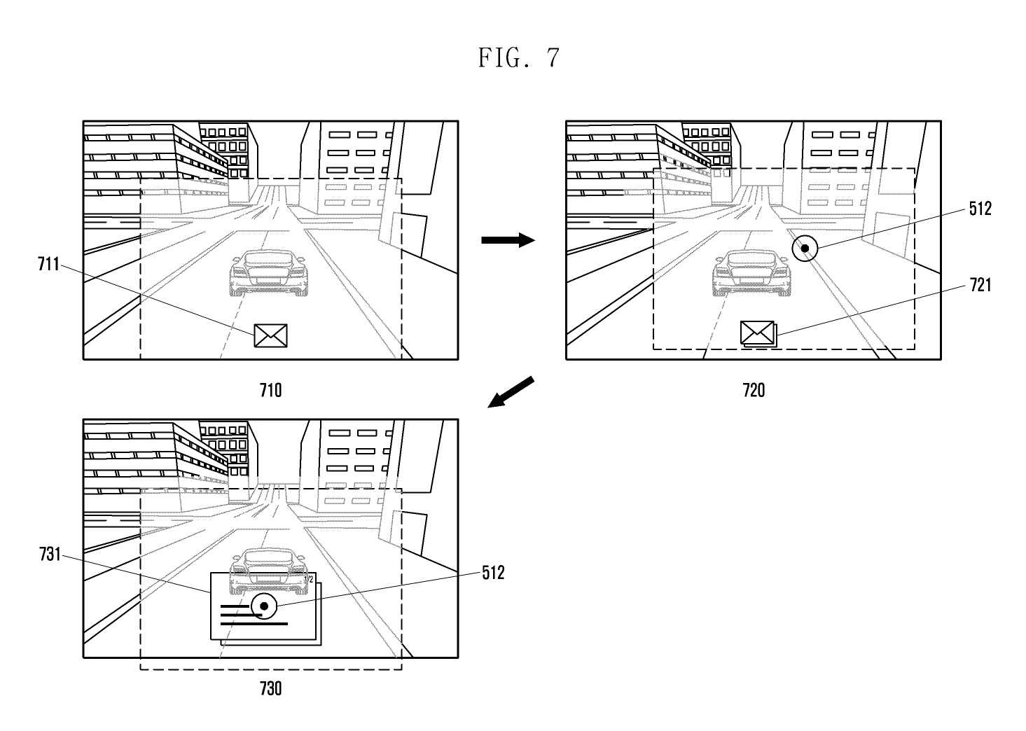

As described above, various kinds of notifications may be generated while the VR content execution screen is displayed. When the notification icon related to the message is generated, a message notification method and a message identification method while a VR content is executed may have various embodiments. Hereinafter, an embodiment of a message notification and message identification method while a VR content is executed will be described with reference to FIGS. 6 and 7.

FIG. 6 illustrates a method of identifying a message during display of a VR content execution screen.

Screenshot 610 displays notification information which is shown when a position of a user's sight line reaches a display window in response to a message reception notification generated while the VR content execution screen is displayed. Since a kind of the notification relates to a message, the notification information may be a message display window 611. In this event, a position of the user's sight line 512 stays in the message display window 611 so that the message display window 611 may continuously be displayed on a screen. Further, “1/3” may be displayed in the upper-right side of the message display window 611, meaning that a message currently being displayed is a first message among three reception messages. Therefore, the user identities the “1/3” displayed in the upper-right side and may perform a pre-configured user input in order to display a next message on the screen. For example, the user may perform a swipe operation on the touch pad 101 attached to a side of the head mount device 100 in order to display the next message.

When the swipe operation 605 is performed while the first message among the three messages is displayed (screenshot 610), a second message may be displayed as shown in screenshot 620. In this event, the position of the user's sight line 512 may be in a state of staying in a message display window 612 where the second message is displayed. Then, when a swipe operation 625 is performed again, a message display window 612 where a third message is displayed may be displayed as shown in screenshot 630. When the third message is a last message among unidentified messages, an end effect 631 may be performed in a right side end of the message display window 613. The end effect 631 may be an operation of changing a color of a side of the message display window 613. When the user performs the swipe operation again in the opposite direction to display the first message, the controller 260 may display the end effect in that there are no more previous messages in a left side end of the message display window 611.

FIG. 7 illustrates a message notification display operation.

As described above, the controller 260 may display the notification icon on at least a portion of the screen when the message is received. When there are multiple received messages according to various embodiments, there may be a method for displaying the messages differently from the single message reception notification. Referring to FIG. 7, as indicated in screenshot 710, the controller 260 may display a message notification icon 711 on a side of the VR content execution screen when one message is received. However, when another message has been received before the received message is identified, that is, when multiple messages have been received, the controller 260 may separately display a multi-message notification icon 721 as shown in screenshot 720. The multi-message notification icon 721 may be displayed as an icon in a shape having overlapping message envelopes. In addition, various icons which can notify of a fact in that multiple unidentified messages exist may be used for the multi-message notification 721.

When the multiple unidentified messages exist, if the position of the user's sight line stays on a position of the multi-message notification icon 721 in order to identify the messages, the controller 260 may display a multi-message display window 731 showing the existence of the multiple messages as shown in screenshot 730. The multi-message display window 731 may appear like multiple single message display windows overlap.

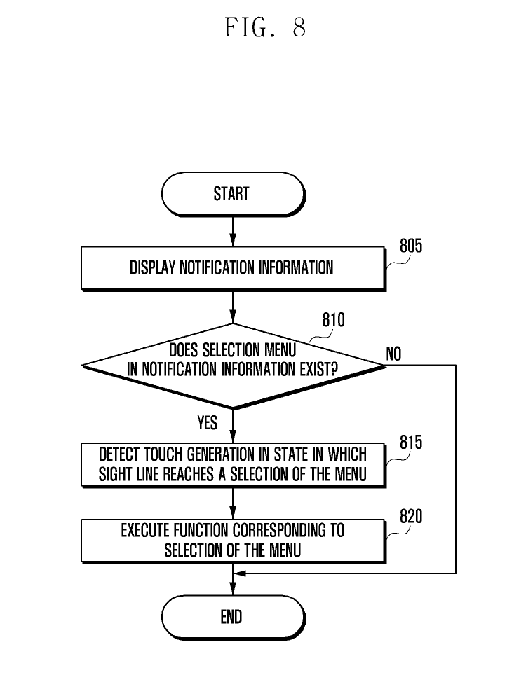

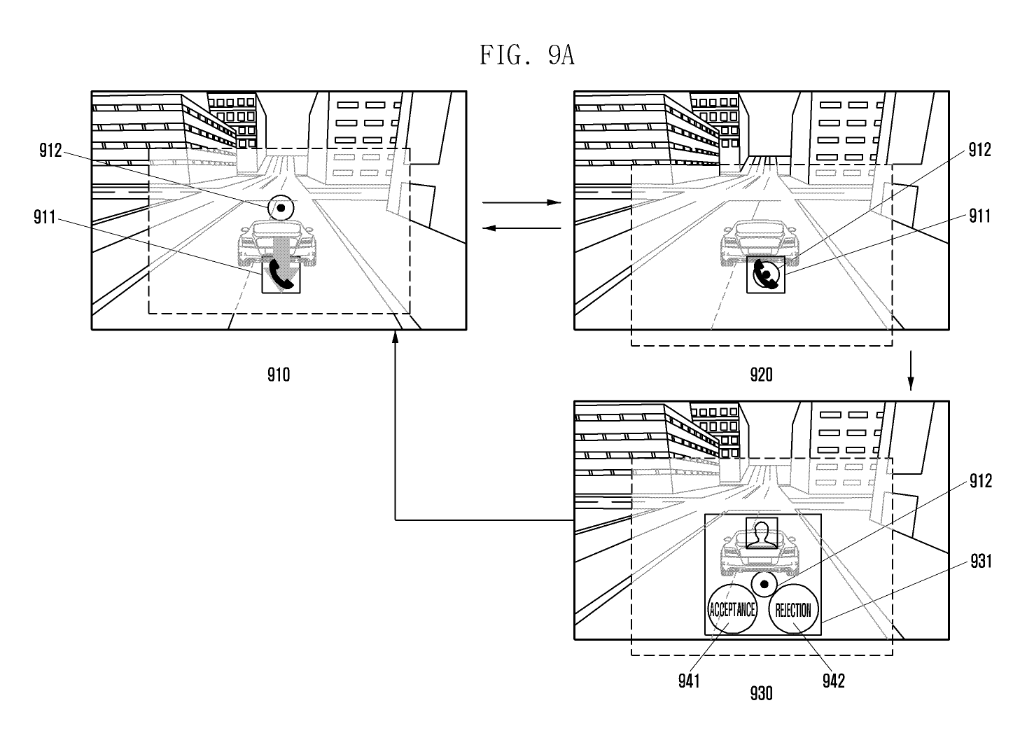

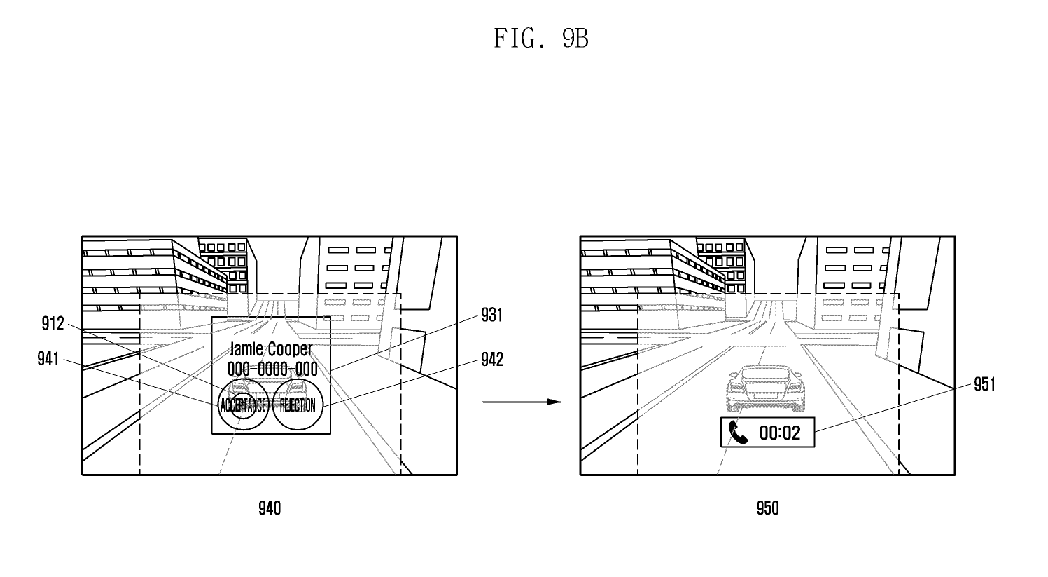

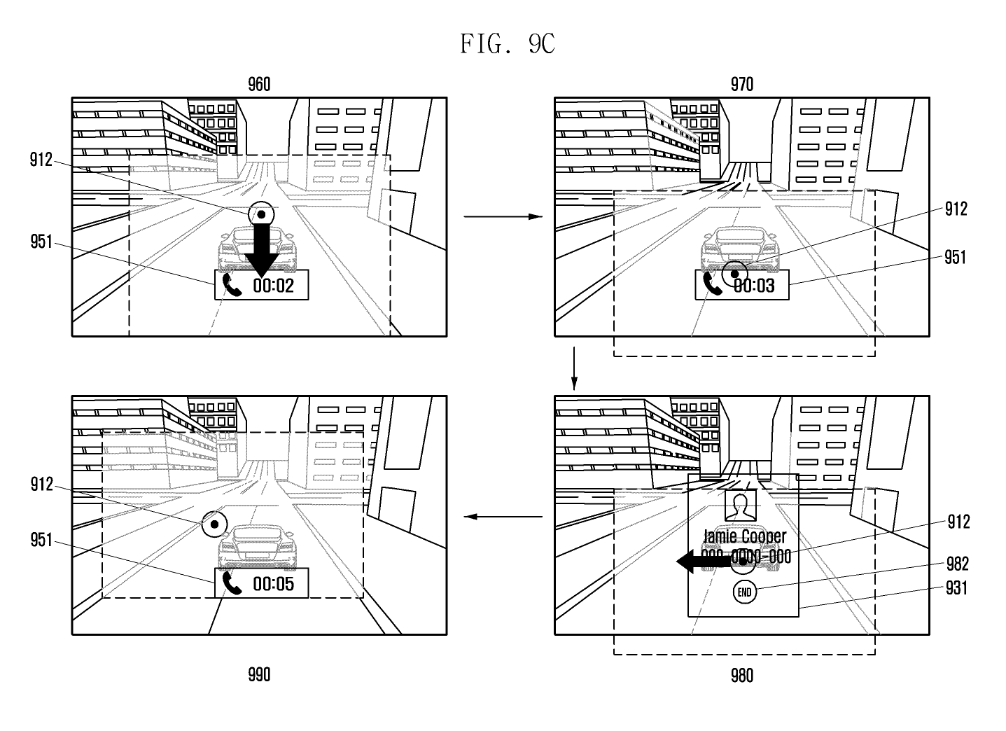

As described above, when various notification situations appear while the VR content execution screen is displayed, the electronic device 200 may display an icon related to a corresponding notification on a side of the screen and different kinds of notification icons may be displayed according to a kind of notification and the number of notifications to be displayed. Hereinafter, various embodiments in which the electronic device 200 displays notification information while displaying the VR content execution screen will be described with reference to FIGS. 8 to 9C.

FIG. 8 is a flow chart illustrating a flow of a notification information display operation during display of a VR content execution screen. FIG. 8 illustrates another embodiment of operation 330 and thereafter in FIG. 3.

Referring to FIG. 8, the controller 260 may display notification information while a VR content execution is displayed in operation 805. In this event, the notification information may be displayed in a form of, for example, a call reception display window, and a message display window. Then, the controller 260 may determine whether a selection menu exists in the notification information in operation 810. Further, the controller 260 may identify that a touch is performed in a state in which a position of the user's sight line reaches the selection menu in operation 815. Whether the position of the user's sight line reaches a specific point can be determined on the basis of the user's head motion sensed through the sensor unit 240 of the electronic device 200. Alternatively, whether the position of the user's sight line reaches the specific point can be determined by a sensor in a camera attached to the electronic device 200 that detects movement of the user's pupil. The touch may be, for example, a tap operation input by the touch pad 101 existing on the side of the head mount device 100. The user may obtain an effect of clicking a corresponding point by tapping the side of the touch pad 101 of the head mount device 100 when the position of the user's sight line reaches a selection of the menu desired by the user himself or herself.

When a specific selection of the menu has been selected by the touch input in a position desired by the user himself or herself, the controller 260 may execute a function corresponding to the selection of the menu in operation 820.

A description for a detailed operation for the drawing in FIG. 8 will be described with reference to FIGS. 9A to 9C. FIGS. 9A to 9C illustrate an operation of displaying a call reception display window.

As shown in screenshot 910 in FIG. 9A, the controller 260 may display a notification icon 911 (e.g., a telephone shape of icon) notifying of a call reception on a side of a screen when a call is received while a VR content execution screen is displayed. In this event, a position of a user's sight line 912 may be in a state of not reaching to an area where the notification icon 911 is displayed. However, when the position of a user's sight line 912 reaches the area where the notification icon 911 is displayed as indicated by screen shot 920, the controller 260 may display notification information as shown in screenshot 930. Since the notification icon 911 corresponds to an incoming call, displayed notification information as shown in screenshot 930 may be a call reception display window 931. Further, when the position of a user's sight line 912 stays in the call reception display window 931, the controller 260 may continuously display the call reception display window 931 on the VR content execution screen. However, when the position of the user's sight line 912 moves outside of the call reception display window 931 while moving in the direction indicated by the arrow, the notification information may be shown in a a notification icon 911.

In this event, the call reception display window 931 may include a selection menu. The selection menu include buttons 941, 942 so as to accept, button 941, or reject a call, button 942. In this event, as shown in FIG. 9B, a user may move the position of the user's sight line 912 to a specific selection of the menu (e.g., an acceptance button 941) desired by the user himself among selection menus (an acceptance button 941 and a rejection button 942) existing in a call reception window 931 and then input a touch gesture to make a selection of the menu. The touch gesture may correspond to, for example, a tap operation on the touch pad 101 formed on a side of the head mount device 100.

In addition, the controller 260 may perform an operation of connecting or terminating a call, in response to the menu selection. When the selected of the menu corresponds to the acceptance button 941, the controller 260 may connect a call and display a call situation display window 951 notifying of a call progress situation instead of the call reception display window 931. In this event, the size of the call situation display window 951 may be minimized and displayed on a side of the screen.

Meanwhile, when the rejection button 942 has been selected even though it is not shown in the drawing, the controller 260 may reject a call reception on the screen and terminate a display of the call reception display window 931.

FIG. 9C illustrates an operation after a call connection. Referring to screenshot 960, after a call is connected, a call situation display window 951 is displayed on a side of the VR content execution screen in a state of being minimized. Further, a position of the user's sight line 912 is positioned outside of the call situation display window 951. When the position of the user's sight line 912 moves in the direction of the arrow as indicated in screenshot 960 and then reaches a position of the call situation display window 951 as indicated by screenshot 970, the controller 260 may display the call situation display window 951 which has been minimized in an original size as indicated by screenshot 980. The call situation display window displayed in the original size 931 may include a button 982 which can select call termination. In addition, while the position of the user's sight line 912 stays in the call situation display window 931, the controller 260 may continuously display the call situation display window 931 in the original size on the screen. However, when the position of the user's sight line 912 moves outside of the call situation display window 931, the call situation display window 931 may be displayed in a minimized size, again, as indicated by screenshot 990.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, or a combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The functions and process steps herein may be performed automatically or wholly or partially in response to user command. An activity (including a step) performed automatically is performed in response to executable instruction or device operation without user direct initiation of the activity.

Meanwhile, the exemplary embodiments disclosed in the specification and drawings are merely presented to easily describe the technical contents of the present disclosure and help with the understanding of the present disclosure and are not intended to limit the scope of the present disclosure. Therefore, all changes or modifications derived from the technical idea of the present disclosure as well as the embodiments described herein should be interpreted to belong to the scope of the present disclosure.

What is claimed is:

1. A method of controlling notification information, the method comprising:
displaying a virtual reality (VR) content execution screen;
displaying a notification icon on at least a portion of the VR content execution screen when a notification is received;
determining that a position of a user's sight line reaches a position at which the notification icon is displayed; and
displaying notification information corresponding to the notification icon on the VR content execution screen.

2. The method of claim 1, wherein the displaying VR content execution screen comprises dividing one display area into two display areas and displaying a screen to be viewed by a left eye and a screen to be viewed by a right eye in the two display areas, respectively.

3. The method of claim 1, wherein the displaying of the notification icon on at least a portion of the VR content execution screen comprises displaying of the notification icon on at least a portion of the VR content execution screen comprises, when notification icons of an identical type are repeatedly generated, overlapping notification icons.

4. The method of claim 3, further comprising:
when notification information corresponding to the overlapping notification icons is displayed, displaying overlapping display windows displaying the notification information .

5. The method of claim 1, wherein the determining comprises:
detecting a motion of an electronic device; and
moving the position of the user's sight line according to the motion.

6. The method of claim 5, further comprising:
terminating a display of the notification icon when the movement of the electronic device is not detected over a period of time from a time the notification icon is displayed.

7. The method of claim 1, wherein the notification icons includes one of a message reception icon, a call reception icon, and a push notification reception of an application icon.

8. The method of claim 1, wherein displaying of the notification information on the VR content execution screen comprises continuously displaying the notification information while the position of the user's sight line stays in an area where the notification information is displayed.

9. The method of claim 8, further comprising at least one of:
terminating a display of the notification information when the position of the user's sight line moves outside of the area where the notification information is displayed; and
minimizing and displaying the notification information.

10. The method of claim 8, wherein displaying of the notification information on the VR content execution screen comprises displaying a next message when a swipe operation is detected in a case in which the notification information displayed on the screen corresponds to a message.

11. The method of claim 8, wherein displaying of the notification information on the VR content execution screen comprises, in a case in which the notification information displayed on the screen includes a selection menu, performing a function corresponding to a selection of the selection menu when a tap operation is detected in a state in which the position of the user's sight line reaches a position where the selection of the selection menu is displayed.

12. An electronic device for controlling notification information, the electronic device comprising:
a display unit for displaying a virtual reality (VR) content execution screen and displaying a notification icon on at least a portion of the virtual reality (VR) content execution screen;
a sensor unit for detecting a motion of the electronic device; and
a controller for a position of a user's sight line according to the detected motion and controlling notification information correspoding to the notification icon on the VR content execution screen when the position of the user's sight line reaches a notification display window.

13. The electronic device of claim 12, wherein the display unit comprises two display areas and displays a screen to be viewed by a left eye and a screen to be viewed by a right eye in the two display areas, respectively.

14. The electronic device of claim 12, wherein the controller is configured to, displaying of the notification icon on at least a portion of the VR content execution screen comprises, when notification icons of an identical type are repeatedly generated, overlapping notification icons.

15. The electronic device of claim 14, wherein the controller is further configured to, when notification information corresponding to the overlapping notification icons is displayed, displaying overlapping display windows displaying the notification information.

16. The electronic device of claim 12, wherein the controller is configured to terminate a display of the notification icon when the motion of the electronic device is not detected over a period of time from a the notification icon is displayed.

17. The electronic device of claim 12, wherein the controller is configured to determine one of a message reception, a call reception, and a push notification reception of an application as the notification.

18. The electronic device of claim 12, wherein the controller is configured to continuously display the notification information while the position of the user's sight line stays in an area where the notification information is displayed.

19. The electronic device of claim 18, wherein the controller is configured to terminate a display of the notification information when the position of the user's sight line moves outside of the area where the notification information is displayed, or minimize and display the notification information.

20. The electronic device of claim 18, wherein the controller is configured to display a next message when a swipe operation is detected in a case in which the notification information displayed on the screen corresponds to a message.

21. The electronic device of claim 18, wherein the controller makes a control to, in a case in which the notification information displayed on the screen includes a selection menu, perform a function corresponding to the selection menu when a tap operation is detected in a state in which the point considered as the position of the user's sight line reaches a position where the selection menu is displayed.
